(19) United States
(12) Patent Application Publication
(10) Pub. No.: US 2012/0199080 A1
(43) Pub. Date: Aug. 9, 2012

(54) Climate Controlled Animal Shelter and Method of Using and Controlling Same

(76) Inventor: Troy B. Siddons, Tucson, AZ (US)

(21) Appl. No.: 13/289,971

(22) Filed: Nov. 4, 2011

Related U.S. Application Data
(60) Provisional application No. 61/410,311, filed on Nov. 4, 2010.

(51) Int. Cl. A01K 1/03

(52) U.S. Cl. 119/448

(57) ABSTRACT

A climate controlled animal shelter and method of controlling a climate controlled animal shelter is presented. The animal shelter includes an interior volume and a climate unit. The climate unit comprises an air conditioner, an evaporative cooler, an electric heater, and a radiant heater. The radiant heater includes a length of tubing attached to the animal shelter, a quantity of heating material disposed within the length of tubing. The heating material is configured to receive thermal energy and radiate the received thermal energy into the interior volume of the animal shelter.

### FIELD

The invention relates to a climate controlled animal shelter and more particularly to a climate controlled energy efficient animal shelter that adjusts its heating and cooling method and activity based on environmental conditions and the presence of the animal in or near the shelter and most particularly to a climate controlled animal shelter that can be remotely monitored and controlled and is capable of issuing alerts for uncomfortable or unsafe conditions within the shelter.

### BACKGROUND

The protection afforded by traditional animal shelters is limited since such shelters generally comprise only a roof and set of walls. Such shelters provide protection from direct sunlight and, in the case of enclosed shelters, provide some degree of temperature protection in colder weather by retaining the heat generated from the animal within the shelter. However, while these animal shelters provide basic protection from the elements, the protection they provide is not well suited for climates of all geographies and/or all seasons of the year. Summer highs and winter lows can be very uncomfortable for most animals and, in some cases, can be deadly even in spite of the animal's natural protection (i.e., fur) and even with access to a traditional animal shelter. As a result, owners oftentimes either keep pets indoors during such conditions, leave their pets exposed to an, at best, uncomfortable or, at worst, deadly situation. Some people living in these climates simply forego owning an animal altogether. In the case of larger animals, such as horses, an indoor shelter is generally not an option.

Some geographic climates are more likely to have extreme temperatures. For example the temperature in the American southwest, including the states of Arizona, New Mexico, and California, can routinely reach upwards of 120° F./49° C. These areas have experienced significant growth in population over the last few decades. Many newcomers to these areas bring with them or acquire one or more house pets or another type of domesticated animal. Oftentimes, these animals are not native to this new area and its harsh climate. As a result, the excessive heat in the summer months pose a potential risk, especially when the animals are kept out of doors.

Another attribute of geographic areas with excessively hot temperatures, such as the aforementioned states and many other global locations that are considered a desert, are their low levels of humidity.

In addition, aside from the owner physically visiting the shelter, traditional animal shelters do not include a means for the animal's owner to monitor the condition within the shelter. In the event of an unsafe condition, such as an abnormally hot day, or the malfunction of a cooling or heating device, the owner may not visit the shelter and therefore not become aware of the unsafe condition.

### SUMMARY

A climate controlled animal shelter is presented. The animal shelter includes an interior volume and a climate unit. The climate unit comprises an air conditioner, an evaporative cooler, an electric heater, and a radiant heater. The radiant heater includes a length of tubing attached to the animal shelter, a quantity of heating material disposed within the length of tubing. The heating material is configured to receive thermal energy and radiate the received thermal energy into the interior volume of the animal shelter.

A method of controlling a climate controlled animal shelter is also presented. The method includes receiving a proximity value, comparing the proximity value with a predetermined proximity set point to find a proximity match, receiving an interior temperature within the animal shelter, comparing said interior temperature with a predetermined temperature range. When the proximity match is found and the interior temperature is outside the predetermined temperature range, activating a climate unit.

### BRIEF DESCRIPTION OF THE DRAWINGS

FIG. 1 depicts one embodiment of Applicant's climate controlled animal shelter;

FIG. 2 depicts one embodiment of Applicant's climate unit 170 that can be retrofitted to an existing animal shelter;

FIG. 3 is a block diagram illustrating the components of one embodiment of Applicant's climate controlled animal shelter;

FIG. 4 is a diagram showing the multiple modes of climate control available for one embodiment of Applicant's invention based on differing values of inside temperature, humidity, and sunlight;

FIG. 5 is a flowchart summarizing one method of using one embodiment of Applicant's climate controlled animal shelter; and

FIG. 6 depicts one embodiment of a solar collection unit for use with Applicant's climate controlled animal shelter.

### DETAILED DESCRIPTION

An animal shelter that is capable of actively regulating, in a low cost and efficient way, the actual temperature within the shelter based on the specific environmental conditions and the presence of the animal near or within the shelter, that can automatically and dynamically change the active heating or cooling method based on environmental conditions, that can be remotely monitored and controlled, and that can inform the animal's owner of an unsafe or uncomfortable condition within the shelter is provided.

This invention is described in preferred embodiments in the following description with reference to the Figs., in which like numbers represent the same or similar elements. Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

The described features, structures, or characteristics of the invention may be combined in any suitable manner in one or more embodiments. In the following description, numerous specific details are recited to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

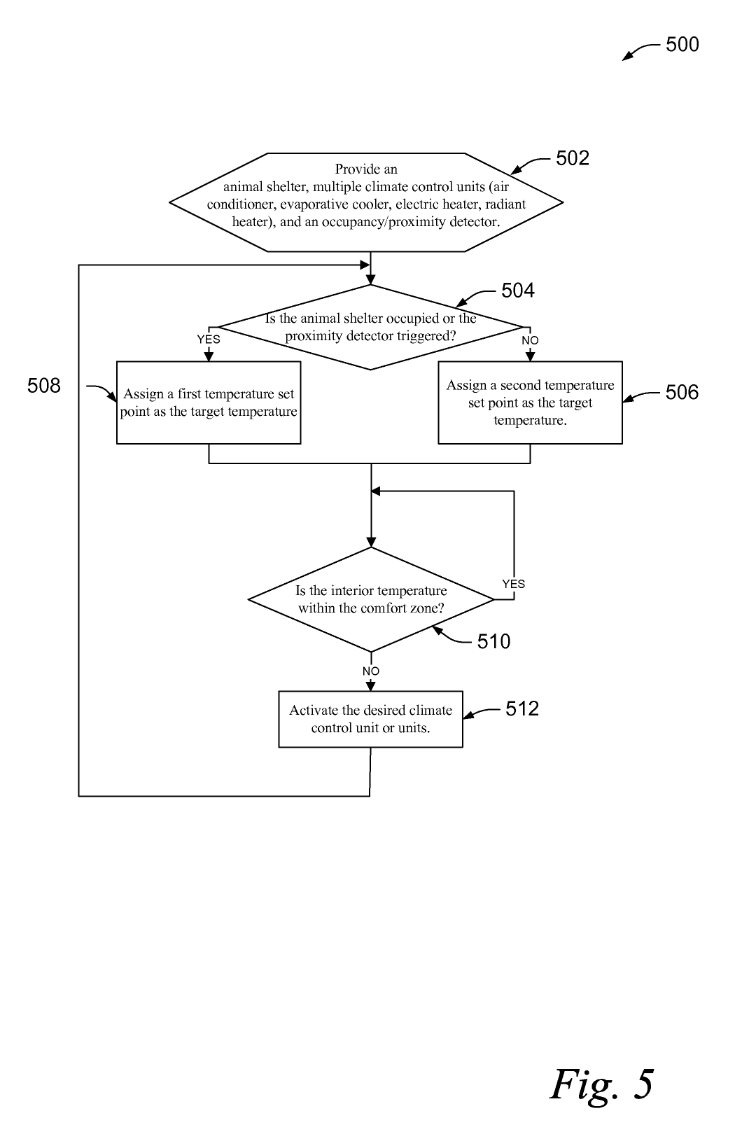

The schematic flow chart diagrams included are generally set forth as logical flow-chart diagrams (e.g., FIG. 5). As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow-chart diagrams, they are understood not to limit the scope of the corresponding method (e.g., FIG. 5). Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

In one embodiment, Applicant's invention is configured to provide a comprehensive climate controlled animal shelter. This includes the physical shelter, to provide protection from the elements, as well as multi-component cooling and/or heating system configured to maintain a predetermined temperature for each of a variety of environmental and occupancy conditions. In another embodiment, Applicant's invention is configured to provide a self-contained multi-component cooling and/or heating system that can be retrofitted to an existing animal shelter.

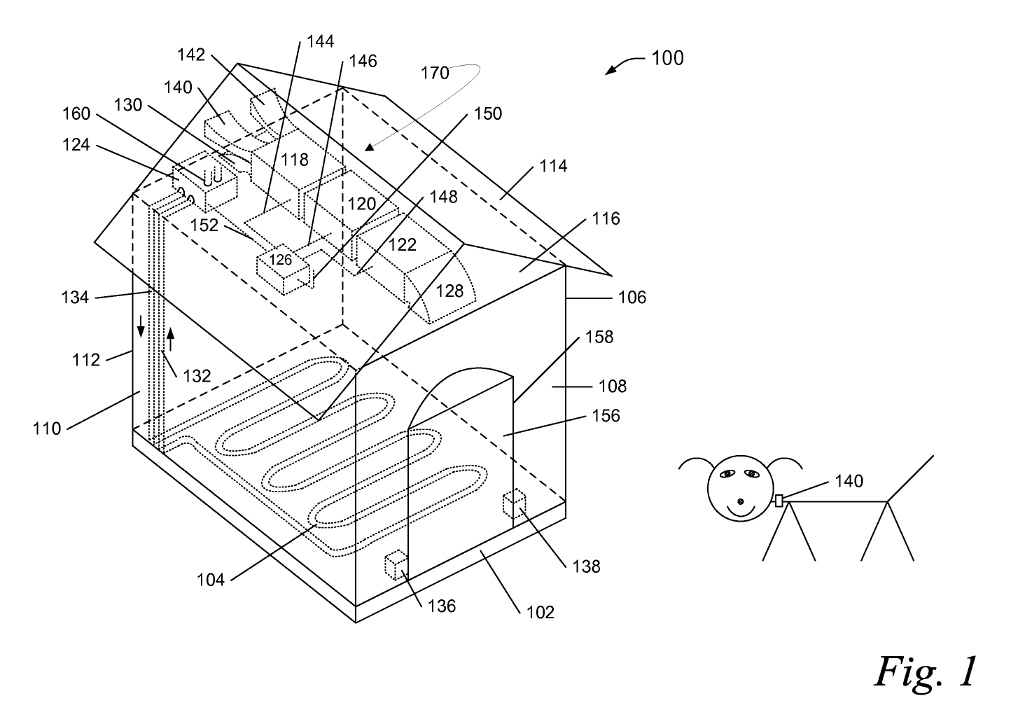

Referring to FIG. 1, one embodiment of Applicant's climate controlled animal shelter 100 is depicted. A base 102 houses heating pipes 104. Four walls 106, 108, 110, 112, support an upper roof 114 and a lower roof 116. In one embodiment, a climate unit 170 is disposed between the upper roof 114 and lower roof 116. In other embodiments, the one or more components of the climate unit 170 is disposed on walls 106, 108, 110, 112, upper roof 114, lower roof 116, base 102, or any combination thereof.

The walls 106, 108, 110, and 112, along with the lower roof 116 and base 102 define an interior volume within the climate controlled animal shelter 100. In certain embodiments, the climate unit 170 is configured to pull, or receive, air from outside the animal shelter 100 or from within the interior volume of the animal shelter 100. The climate unit 170 treats the air (i.e., by heating or cooling) and delivers the treated air into the interior volume of the animal shelter 100.

The climate unit 170 includes an air conditioner unit 118. In one embodiment, the air conditioning unit 118 includes a compressor, cooling coils, condensing coils, and a fan. Air enters the air conditioning unit 118 through an inlet duct 130. In one embodiment, the temperature of the air is lowered as it passes over the cooling coils. The heat extracted from the air is absorbed by a refrigerant in the cooling coils. The heated refrigerant enters the condenser coils. Fan draws air through the inlet 140, across the condenser coils, and out of the outlet 142, thereby extracting the heat from the refrigerant, and expelling it into the atmosphere. In one embodiment, the inlet 140 and outlet 142 have opposing vents that prevent heated air expelled from the outlet 142 from being drawn back into the inlet 140 and thereby decreasing the efficiency of the air conditioner 118.

An attribute of geographic areas with excessively hot temperatures, such as the United States southwest and other arid global locations, are their low levels of humidity. One effective method of cooling in such climates is evaporative cooling, which provides the same level of cooling with up to 80 percent less energy consumption than air conditioners, in some conditions. In evaporative cooling, water mist is added to the ambient air. The water strikes a surface and evaporates. During evaporation, the water absorbs an amount of energy equivalent to the latent heat of evaporation from the surface, thereby cooling the surface. Because evaporative cooling requires the evaporation of air, evaporative cooling is only effective when a sufficient difference exists between the dry bulb temperature (the temperature measured with a dry thermometer) and the wet bulb temperature (the temperature measured with a wet thermometer exposed to a flow of air). The delta between the dry bulb and wet bulb temperatures depends on the humidity of the air (i.e., moisture in the air). Evaporation, and therefore the cooling effect, is increased with decreased humidity of the air.

The climate unit 170 includes an evaporative cooler 120, which further includes a primary fan. In one embodiment, the evaporative cooler 120 includes a cooler pad. In different embodiments, the cooler pad is composed of excelsior (i.e., wood wool), plastics, melamine paper, or a combination thereof. The cooler pad is saturated with water from a water source. Dry air (i.e., air with low humidity) is drawn through the water-saturated cooler pad. The water evaporates from the cooler pad, lowering the temperature of the cooling pad, thereby cooling the air as it flows through the cooling pad.

In one embodiment, the evaporative cooler 120 includes a series of mist heads. As air flows through the evaporative cooler 120, water mist, from a water source, is added to the air through the mist heads. The mist-laden air is expelled into the interior of the climate controlled animal shelter 100. As the mist-laden air strikes surfaces within the interior of the climate controlled animal shelter 100, including any animal residing therein, the water evaporates, thereby cooling the surface.

In one embodiment, the evaporative cooler 120 has an outlet port that expels the cool or mist-laden air down into the interior of the climate controlled animal shelter 100.

The climate unit 170 includes an electric forced air heater 122. In one embodiment, the electric forced air heater 122 includes a heater element. The heater element heats as electricity, from an electric source, passes through the heater element. Cool air is drawn over the heater element and is heated.

In one embodiment, the inlet duct 130 is connected to the air conditioner 118. The air conditioner 118 is connected to the evaporative cooler 120. The electric forced air heater 122 is connected to outlet duct 128. As such, air can flow from the inlet duct 130, through each of the air conditioner 118, the evaporative cooler 120, the electric forced air heater 122, and out of the outlet duct 128. The primary fan, housed in the evaporative cooler, draws outside air into the inlet port 130. The primary fan pulls the air through the air conditioner 118 and over the cooling coils within the air conditioner 118. The primary fan further forces air, in one embodiment, through the cooler pad or, in another embodiment, past the mist heads. The primary fan further forces the air through the electric forced air heater 122, out the outlet duct 128, and into the interior of the climate controlled animal shelter 100.

The climate unit 170 includes a radiant heater 124. In one embodiment, the radiant heater includes an electric heater element and a circulation pump. The circulation pump circulates a heating material down a pipe 134, through a radiant heater loop 104, and up a pipe 132. In one embodiment, the heating material comprises water. In one embodiment, the heating material comprises propylene glycol. In one embodiment, the heater loop 104 is embedded in the base 102 of the climate controlled animal shelter 100. As the heating material flows through the radiant heater loop 104, the heat (i.e., thermal energy) is radiated into the interior of the climate controlled animal shelter 100. In one embodiment, the base 102 is placed on an insulating surface to prevent heat from escaping through the base. In one embodiment, a radiant barrier (a reflective barrier that inhibits the transfer of heat) is placed under the radiant heater loop 104 to reflect heat up into the interior of the climate controlled animal shelter 100 instead of escaping through the base 102. In other embodiments, the radiant heater loop is disposed in or embedded on walls 106, 108, 110, 112, upper roof 114, lower roof 116, or any combination thereof

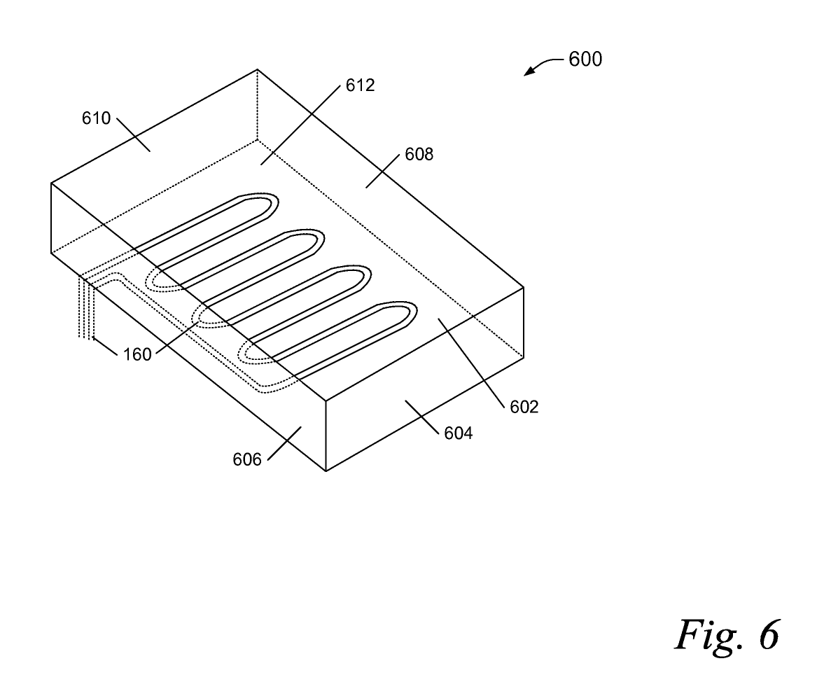

In one embodiment, the radiant heater 124 includes solar energy collection pipes 160 that are partially disposed within a solar collection unit 600 in FIG. 6. Turning to FIG. 6, in one embodiment, a solar collection unit 600 is mounted exterior to the climate controlled animal shelter 100. In one embodiment, the solar collection unit 600 is mounted on the upper roof 114 of the shelter. In one embodiment, the solar collection unit 600 is mounted on a nearby surface that has an unobstructed view of the sky. The solar collection unit 600 has a top 602 with the remaining interior surfaces (sides 604, 606, 608, 610 and bottom 612) coated with a black material. Sunlight enters the top 602, strikes the black material, and is converted to thermal energy. In one embodiment, the black material comprises black paint. In different embodiments, the top 602 comprises glass, acrylic, optically transparent plastic, or a combination thereof. While the top 602 allows sunlight to pass freely, the top 602 traps the thermal energy within the solar collection unit 600. The thermal energy thereby heats the heating material disposed, and circulating, within the solar energy collection pipes 160. Returning back again to FIG. 1, in certain embodiments, the radiant heater 124 then circulates the heating material through the radiant heater loop 104. In other embodiments, the radiant heater 124 then circulates the heating material through a radiant heater loop other than radiant heater loop 104.

In one embodiment, a control unit 126 is electrically connected to the air conditioner 118 by connection 144, to the evaporative cooler 120 by connection 146, to the electric forced air heater 122 by connection 148, and to the radiant heater 124 by connection 152. Control unit 126 controls the flow of air through the climate unit 170. Control unit 126 also controls the operation of the air conditioner 118, the evaporative cooler 120, the electric forced air heater 122, and the radiant heater 124. The control unit 126 receives exterior environmental data, including the dry bulb temperature and the relative humidity, from the exterior of the climate controlled animal shelter 100. In one embodiment, the control unit 126 is an Internet-connected device and the environmental data is received from a source on the Internet. In one embodiment, the control unit 126 receives the information wirelessly from a sensor fixed to the exterior of the climate controlled animal shelter 100. In one embodiment, the control unit 126 receives the information from a sensor that is fixed to the exterior of the climate controlled animal shelter 100 and that is electrically connected to the control unit 126.

The control unit 126 receives interior environmental data, including the dry bulb temperature and the relative humidity, from the interior of the climate controlled animal shelter 100. In one embodiment, the control unit 126 receives the information wirelessly from a sensor fixed to the interior of the climate controlled animal shelter 100. In one embodiment, the control unit 126 receives the information from a sensor that is fixed to the interior of the climate controlled animal shelter 100 and that is electrically connected to the control unit 126.

The control unit has an antenna 150. The antenna 150 broadcasts and receives signals from a collar-based transmitter 140. The control unit 126, in combination with the antenna 150 and the collar-based transmitter 140, is configured to detect when the collar-based transmitter 140 is in close proximity to the antenna 150. In one embodiment, the control unit 126 can detect the collar-based transmitter 140 when the collar-based transmitted 140 is within at least 30 feet of the antenna 150. In one embodiment, the control unit 126 can detect the collar-based transmitter 140 when the collar-based transmitted 140 is within 10 feet of the antenna 150. In one embodiment, the control unit 126 can detect the collar-based transmitter 140 when the collar-based transmitted 140 is within 3 feet of the antenna 150. In one embodiment, the control unit 126 can detect the distance between the control unit 126 and the collar-based transmitter 140 within +/−3 feet.

A door 156 covers the door opening 158 of the climate controlled animal shelter 100. In one embodiment, the door 156 is insulated to reduce heat transfer into or out of the interior of the climate controlled animal shelter 100. In one embodiment, the door 156 comprises multiple length of overlapping flexible plastic strips hanging vertically from the top of the door opening 158. The strips allow an animal to easily enter and exit the climate controlled animal shelter 100 while quickly overlapping to seal the door opening 158. In one embodiment, the door is an electronic door operated by the controller unit 126. In one embodiment, the door comprises a single plastic flap. In one embodiment, the door comprises dual plastic flaps, one disposed within the outer portion of opening 158 and one disposed within the interior portion of opening 158. In one embodiment, the door comprises two portions in a saloon style door configuration. In one embodiment, the door comprises a plurality of segments.

Two locking mechanisms 136 and 138 are configured to optionally lock or unlock the door (i.e., prevent it from opening or permitting it to open, respectively). In one embodiment, the locking mechanisms 136 and 138 are electrically connected to the control unit 126. In one embodiment, the locking mechanisms 136 and 138 are in wireless communication with the control unit 126. In one embodiment, the control unit 126 is configured to unlock the door 156 when collar-based transmitter 140 is within proximity of the control unit 126. When the collar-based transmitter 140 is outside the proximity of the control unit 126, the control unit 126 is configured to lock the door 156. As a result, animals that are not equipped with a collar-based transmitter 140 are unlikely to gain access to the interior of the climate controlled animal shelter 100. This feature is especially desirable because the more favorable interior conditions may draw animals others than those that are intended to use the climate controlled animal shelter 100.

In one embodiment, power is supplied to the climate controlled animal shelter 100 by solar panels fixed to the upper roof 114 and used to offset the overall cost of energy consumed by the climate controlled animal shelter 100.

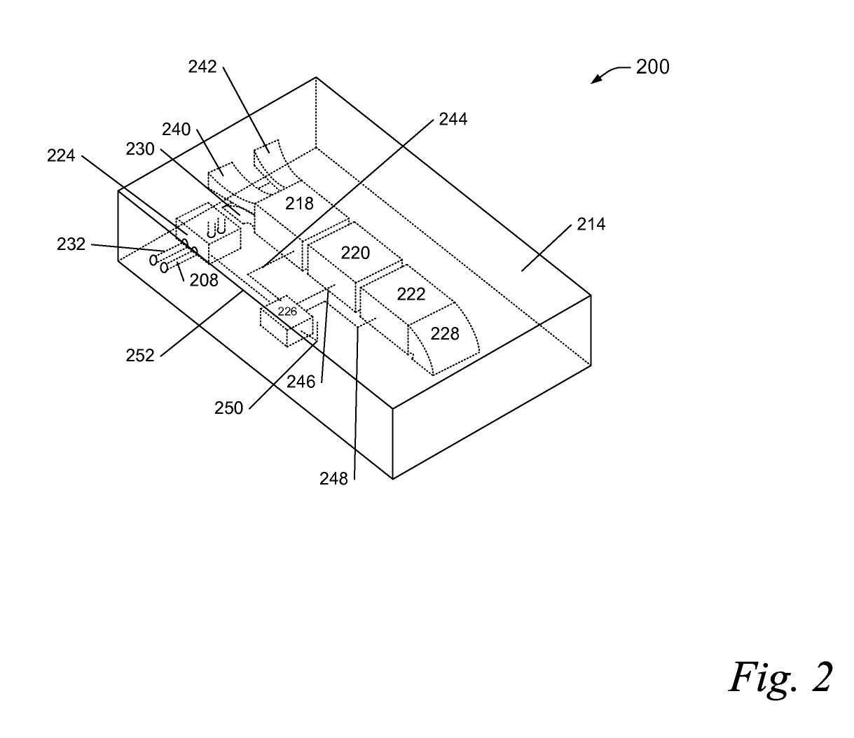

Referring to FIG. 2, one embodiment of a self-contained multi-component climate unit 200 that can be retrofitted to an existing animal shelter is depicted. The climate unit 200 requires a source of electrical power and a source of water (connections not shown). In one embodiment, the climate unit 200 is affixed to the roof of an existing animal shelter. In another embodiment, the climate unit 200 is affixed to a vertical wall of an existing animal shelter. The climate unit 200 transforms the interior of any existing, enclosed animal shelter that has access to a source of electricity and water, into a climate-controlled environment.

The climate unit 200 includes a housing 214. A bottom surface 210 of the housing 214 is configured to attach to an existing animal shelter.

The climate unit 200 includes an air conditioner unit 218. In one embodiment the air conditioning unit 218 includes a compressor, cooling coils, condensing coils, and a fan. Air enters the air conditioning unit 218 through an inlet duct 230. In one embodiment, the temperature of the air is lowered as it passes over the cooling coils. The heat extracted from the air is absorbed by a refrigerant in the cooling coils. The heated refrigerant enters the condenser coils. The fan draws air through the inlet 240, across the condenser coils, and out of the outlet 242, thereby extracting the heat from the refrigerant, and expelling it into the atmosphere. In one embodiment, the inlet 240 and outlet 242 have opposing vents that prevent heated air expelled from the outlet 242 from being drawn back into the inlet 240 and thereby decreasing the efficiency of the air conditioner 218.

The climate unit 200 includes an evaporative cooler 220, which further includes a primary fan. In one embodiment, the evaporative cooler 220 includes a cooler pad. In different embodiments, the cooler pad is composed of excelsior (i.e., wood wool), plastics, or melamine paper. The cooler pad is saturated with water from a water source. Dry air (i.e., air with low humidity) is drawn through the saturated cooler pad. The water evaporates from the cooler pad, lowering the temperature of the cooling pad, thereby cooling the air as it flows through the cooling pad.

In one embodiment, the evaporative cooler 220 includes a series of mist heads. As air flows through the evaporative cooler 220, water mist (from a water source) is added to the air through the mist heads. The mist-laden air is expelled from the climate unit 200.

The climate unit 200 includes an electric heater 222. In one embodiment, the electric heater 222 includes a heater element. The heater element heats as electricity, from an electric source, passes through the heater element. Cool air is drawn over the heater element and heated.

In one embodiment, the inlet duct 230 is connected to the air conditioner 218. The air conditioner 218 is connected to the evaporative cooler 220. The electric heater 222 is connected to outlet duct 228. As such, air can flow from the inlet duct 230, through each of the air conditioner 218, the evaporative cooler 220, the electric heater 222, and out of the outlet duct 228. The primary fan, housed in the evaporative cooler, draws air from the interior of the shelter and into the inlet port 230. The primary fan pulls the air through the air conditioner 218 and over the cooling coils within the air conditioner 218. The primary fan further forces air, in one embodiment, through the cooler pad or, in another embodiment, past the mist heads. The primary fan further forces the air through the electric heater 222, out the outlet duct 228, and back into the interior of the shelter.

The climate unit 200 includes a radiant heater 224. In one embodiment, the radiant heater includes an electric heater element and a circulation pump. The circulation pump circulates a heating material through a pipe 208, through a radiant heater loop 204 placed on the floor of the shelter (not shown), and back through a pipe 232. As the heating material flows through the radiant heater loop, the heat is radiated into the interior of the shelter. In one embodiment, a radiant barrier (a reflective barrier that inhibits the transfer of heat) is placed under the radiant heater loop 204 to reflect heat up into the interior of the climate unit 200 instead of escaping into the ground.

In one embodiment, a control unit 226 is electrically connected to the air conditioner 218 by connection 244, to the evaporative cooler 220 by connection 246, to the electric heater 222 by connection 248, and to the radiant heater 224 by connection 252. Control unit 226 controls the flow of air through the climate unit 200. Control unit 226 also controls the operation of the air conditioner 218, the evaporative cooler 220, the electric heater 222 and the radiant heather 224. The control unit 226 receives ambient environmental data (i.e., external to the climate unit 200 or to any attached animal shelter), including the dry bulb temperature and the relative humidity, exterior to the climate unit 200. In one embodiment, the control unit 226 is an internet-connected device and the ambient environmental data is received from a source on the internet. In one embodiment, the control unit 226 receives the ambient environmental data wirelessly from a sensor fixed to the exterior of the shelter. In one embodiment, the control unit 226 receives the ambient environmental data from a sensor that is fixed to the exterior shelter and that is electrically connected to the control unit 226.

The control unit 226 receives internal environmental data, including the dry bulb temperature and the relative humidity, interior to the shelter. In one embodiment, the control unit 226 receives the internal environmental data wirelessly from a sensor fixed to the interior of the shelter. In one embodiment, the control unit 226 receives the internal environmental data from a sensor that is fixed to the interior of the shelter and that is electrically connected to the control unit 226.

The control unit has an antenna 250. The antenna 250 broadcasts and receives signals from a collar-based transmitter. The control unit 226, in combination with the antenna 250 and the collar-based transmitter, in configured to detect when the collar-based transmitter is in close proximity to the antenna 250. In one embodiment, the control unit 226 can detect the collar-based transmitter when the collar-based transmitted is within 30 feet of the antenna 250. In one embodiment, the control unit 226 can detect the collar-based transmitter when the collar-based transmitter is within 10 feet of the antenna 250. In one embodiment, the control unit 226 can detect the collar-based transmitter when the collar-based transmitter is within 3 feet of the antenna 250. In one embodiment, the control unit 226 can detect the distance between the control unit 226 and the collar-based transmitter 240 within +/−3 foot.

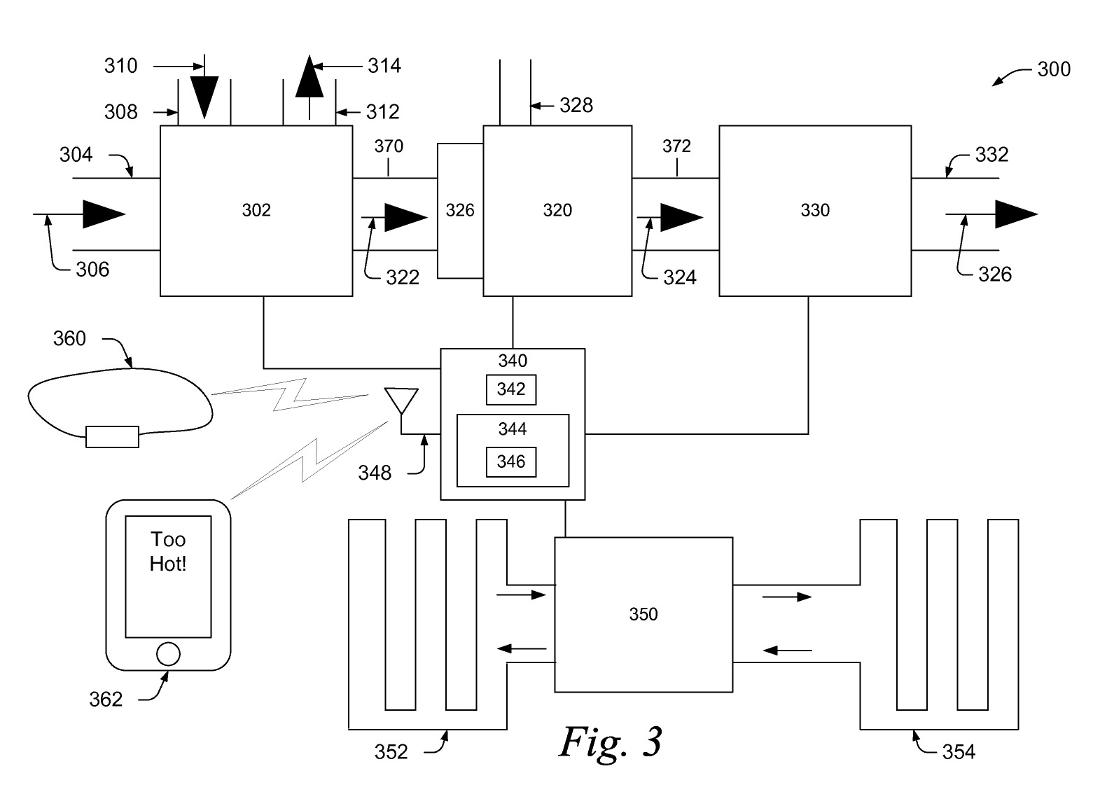

Referring to FIG. 3, a block diagram 300 depicts one embodiment of Applicant's climate controlled animal shelter. In one embodiment, a control unit 340 comprises processor 342, computer readable medium 344, computer readable program code 346 encoded in computer readable medium 344, and wireless communication interface 348. Processor 342, using computer readable program code 346 controls the operation of air conditioner 302, evaporative cooler 320, electric heater 330, and radiant heater 350.

The control unit 340 receives environmental data from both the interior and the exterior of the climate controlled animal shelter. In one embodiment, the exterior (i.e., ambient) environmental data is received from an internet source over a wireless connection, such as Wi-Fi, by the wireless communication interface 348. In one embodiment, the exterior environmental data is received from sensors placed outside the climate controlled animal shelter through a wired or wireless connection. In one embodiment, the interior environmental data is received from sensors placed inside the climate controlled animal shelter through a wired or wireless connection.

The control unit 340 activates one or a combination of the air conditioner 302, the evaporative cooler 320, the electric heater 330, or the radiant heater 350 based on the interior environmental data, the exterior environmental data, and one or more temperature set points.

Low energy cooling. In one embodiment, when the control unit 340 determines that the interior temperature is above a predetermined set point and the control unit 340 further determines that the humidity is below a predetermined level, the control unit 340 will cool the interior of the climate controlled animal shelter by activating the evaporative cooler 320, while the air conditioner 302, the electric heater 330, and the radiant heater 350 remain disabled.

The evaporative cooler 320 includes a blower 326. In one embodiment, the blower 326 is configured to drive a stream of air through the air conditioner 302, the evaporative cooler 320, and the electric heater 330 as indicated by arrows 306, 322, 324, and 326. The air conditioner 302 is connected to (i.e., is in fluid communication with) the evaporative cooler 320 by conduit 370. The evaporative cooler 320 is connected to (i.e., is in fluid communication with) the electric heater by the conduit 372. The inlet port 304 draws air from the interior of the climate controlled animal shelter and the outlet port 332 feeds air back into the interior of the climate controlled animal shelter. The air conditioner 302, the evaporative cooler 320, and the electric heater 330 therefore process air from the interior of the shelter and return it back into the shelter.

The evaporative cooler 320 receives water from a water source 328. In one embodiment, the water is forced under pressure through mist heads, creating a mist of water vapor. The mist of water vapor enters the stream of air flowing through the evaporative cooler 320. The resulting humidified air travels through electric heater 330 and out of the outlet 332, exiting into the interior of the climate controlled animal shelter. When the humidified air strikes a surface within the shelter, the water mist contacts the surface and evaporates, cooling the surface. In another embodiment, the water is added to a cooling pad. As the air stream passes over the cooling pad, the water evaporates, cooling the air. The resultant cool air travels through electric heater 330 and out of the outlet 332, exiting into the interior of the climate controlled animal shelter. In one embodiment, the evaporative cooler has a baffle that allows the air stream to bypass the cooling pad when the evaporative cooler is not activated.

High Energy Cooling. In one embodiment, when the control unit 340 determines that the interior temperature is above a predetermined set point and the control unit 340 further determines that the humidity is above a predetermined level, the control unit 340 will cool the interior of the climate controlled animal shelter by activating the air conditioner 302, while the evaporative cooler 320 (aside from the blower 326), the electric heater 330, and the radiant heater 350 remain disabled.

In one embodiment, the blower 326 is configured to drive a stream of air through the air conditioner 302, the evaporative cooler 320, and the electric heater 330 as indicated by arrows 306, 322, 324, and 326. A stream of air is drawn from the interior of the climate controlled animal shelter and into an air conditioner 302 by an intake 304, as indicated by arrow 306. The stream of air is cooled by drawing the stream of air over cooling coils within the air conditioner 302. The heat extracted from the stream of air is transferred to a second stream of air drawn from the exterior of the climate controlled animal shelter from an intake 308, as indicated by arrow 310. The heat is transferred to the second stream of air as it passes over condenser coils in the air conditioner 302. The heat is expelled with the second stream of air through outlet 312, as indicated by arrow 314. The cooled stream of air passes through the evaporative cooler 320, the electric heater 330, and out of the outlet 332, exiting into the interior of the climate controlled animal shelter.

Low Energy Heating. In one embodiment, when the control unit 340 determines that the interior temperature is below a predetermined set point and the control unit 340 further determines that the available energy imparted by solar radiation is above a predetermined level, the control unit 340 will heat the interior of the climate controlled animal shelter by activating the radiant heater 350, while the air conditioner 302, the evaporative cooler 320, and the electric heater 330, remain disabled.

In one embodiment, the radiant heater 350 contains a pump for circulating a heating material through the solar energy collection pipes 352 and the radiant heater pipes 354. In one embodiment, the solar energy collection pipes 352 are disposed inside a solar collection box. The solar collection box is mounted exterior to the climate controlled animal shelter, such as on the roof of the shelter or on a nearly non-shaded surface that has an unobstructed view of the sky. The solar collection box has an optically transparent top, comprised in different embodiments of glass or optically transparent plastic, with the remaining 5 interior surfaces coated with a black material. Sunlight enters the optically transparent top and strikes the black material, where the sunlight is converted to thermal heat. While the optically transparent top allows sunlight to freely pass, the optically transparent top traps the thermal heat within the solar collection box. The thermal energy thereby heats the heating liquid within the solar energy collection pipes 352.

The heated heating liquid is next pumped through the radiant heater pipes 354. The radiant heater pipes are configured to allow the heat in the heating material to radiate into the interior of the climate controlled animal shelter.

In one embodiment, the radiant heat also includes an electric heater. The electric heater may be used to supplement the heat gathered from solar radiation in situations where the heat gathered from solar radiation alone is not sufficient to heat the floor of the shelter to the desired temperature. The electric heater uses electricity to further heat the heating material before it enters the radiant heating pipes 354.

High Energy Heating. In one embodiment, when the control unit 340 determines that the interior temperature is below a predetermined set point and the control unit 340 further determines that the available energy imparted by solar radiation is below a predetermined level or the delta in temperature between the set point and the exterior is to large for radiant heating, the control unit 340 will heat the interior of the climate controlled animal shelter by activating the electric heater 330, while the air conditioner 302, the evaporative cooler 320 (aside from the blower 326), and the radiant heater 350, remain disabled.

In one embodiment, the blower 326 is configured to drive a stream of air through the air conditioner 302, the evaporative cooler 320, and the electric heater 330 as indicated by arrows 306, 322, 324, and 326. In one embodiment, the electric heater contains heating coils that generate heat. The heating coils heat the stream of air before it exits to the interior of the climate controlled animal shelter through outlet port 332.

Wireless Communication. In one embodiment, the control unit comprises a proximity sensor that is in two-way wireless communication with a collar-based transmitter 360. The proximity sensor and collar-based transmitter 360 are configured to allow the control unit 340 to detect when the collar-based transmitter 360 is within a predetermined proximity of the wireless communication interface 348.

In one embodiment, the control unit 340 is configured with one or more unoccupied temperature set points for situations where the collar-based transmitter is not with a predetermined proximity of the wireless communication interface 348. The unoccupied temperature set point is set between the exterior temperature and the desired interior temperature set point assuming the climate controlled animal shelter was occupied. There are typically two normal interior temperature set points, one for heating and one for cooling, to maintain a comfortable temperature when the shelter is occupied. There are also two unoccupied temperature set points to limit energy and water consumption when the shelter is unoccupied, allowing for even greater energy savings and a lower cost of operation.

In one embodiment, the control unit may engage in two-way contactless communication with a wireless device 362 through the wireless communication interface 348. In different embodiments, the wireless device 362 may be a smart phone, a cell phone, a computer, or a personal digital assistant (PDA). In one embodiment, the wireless device is used to manually control all functions of the climate controlled animal shelter that would normally be operated according to the instructions in the computer readable program code 346. In one embodiment, the wireless device can be used to remotely monitor the condition and operation of the shelter.

In one embodiment, the wireless device 362 receives alerts issued by control unit 340. The control unit 340 may issue alerts, for example, when the interior temperature is outside of the set points for a prolonged time, when the interior conditions are determined to be unsafe for an animal, when one of the climate control units 302, 326, 320, 330, and 350 are not operating properly, or when the collar-based transmitter has been outside of proximity of the shelter for an extended time. In one embodiment, the control unit 340 reports the amount of energy used by the climate controlled animal shelter.

In one embodiment, the control unit incorporates an algorithm to track changes in interior temperature based on exterior climate conditions, the effect of the various elements of the climate control units 302, 326, 320, 330, and 350, and the rate of energy consumption under various modes of operation. The algorithm may be configured to automatically operate the climate control units 302, 326, 320, 330, and 350 to achieve the desired interior temperature set point while minimizing energy consumption.

In one embodiment, the wireless communication interface 348 is in communication with a wireless internet router, allowing the wireless device 362 to be any Internet connected device, and therefore allow worldwide monitoring of, control of, and receipt of alerts from the climate controlled animal shelter.

In different embodiments, the climate controlled animal shelter may include one or more of the climate control units 302, 326, 320, 330, and 350. For example, in very hot climates where the outside temperature rarely approaches freezing, the electric heater 330, the radiant heater 350, or both are omitted. Similarly, in temperate or humid climates, the air conditioner 302, the evaporative cooler 320 (aside from the blower 326), or both are omitted. In one embodiment, only the blower 326 and one of the climate control units 302, 320, 330, and 350 is included. In one embodiment, only the radiant heater 350 is included. Corresponding

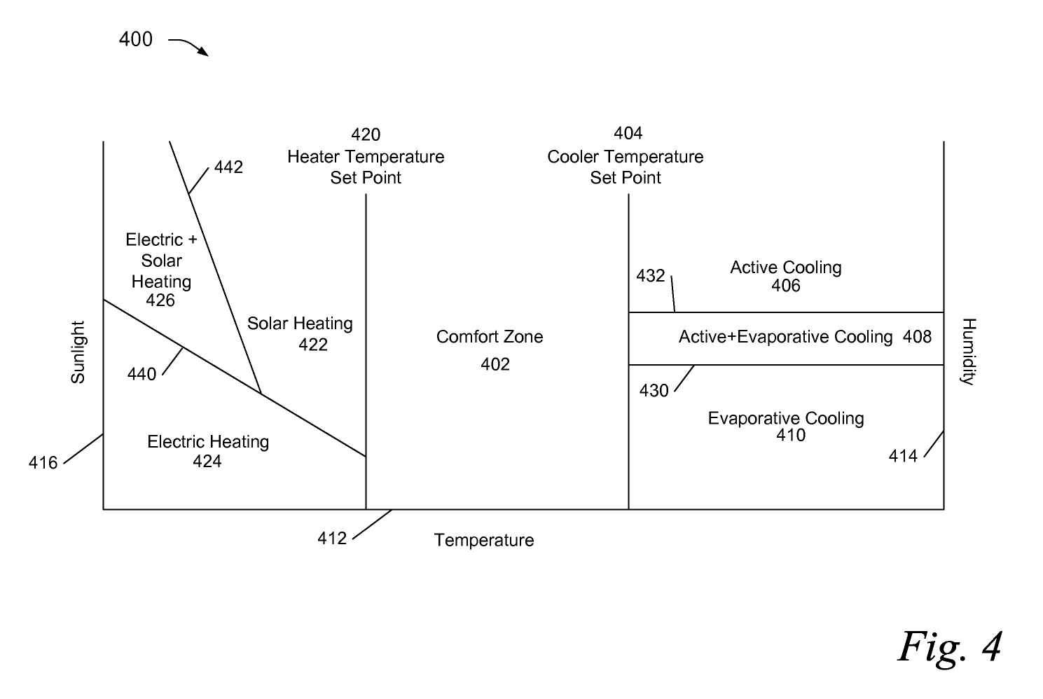

Referring to FIG. 4, a diagram 400 depicts the multiple modes of climate control available and their operation based on differing values of inside temperature, humidity, and sunlight. Interior temperature is represented by the x-axis 412. The heater temperature set point 420 and cooler temperature set point 404 determine the comfort zone 402 in the interior of the climate controlled animal shelter. The control unit will operate the air conditioner, evaporative cooler, electric heater, and radiant heater in one of at least 7 modes, corresponding to areas 426, 422, 424, 402,406, 408 and 410, to maintain the interior temperature within the comfort zone 402 according to the instructions in the computer readable program code 346 of FIG. 3.

Cooling. If the interior temperature is above the cooler temperature set point 404, one embodiment of Applicant's invention operates according to the right side of the diagram 400, where the far right y-axis 414 represents the level of humidity in the outside air. If the outside humidity is below a first predetermined set point 430, the evaporative cooler is activated (represented by area 410), cooling the interior of the climate controlled animal shelter in an energy efficient manner. In some conditions, evaporative cooling can achieve the same level of cooling as an air conditioner but with 80 percent less energy consumption.

If the outside humidity is above the first predetermined set point 430 and below a second predetermined set point 432, both the air conditioner and the evaporative cooler are activated (represented by area 408). At this level of humidity, the evaporative cooler alone is not sufficient to reduce the interior temperature. Instead, the evaporative cooler supplements the cooling of the air conditioner, resulting in less overall energy consumed than using the air conditioner alone.

If the outside humidity is above the second predetermined set point 432, the air conditioner alone is used to cool the interior of the climate controlled animal shelter (represented by area 406). At this level of humidity, the evaporative cooler does not provide adequate cooling.

Heating. If the interior temperature is below the heater temperature set point 420, one embodiment of Applicant's invention operates according to the left side of the diagram 400, where the far left y-axis 416 represents the amount of solar radiation falling on the shelter (i.e., incident solar radiation). If the level of sunlight falling on the climate controlled animal shelter is below a predetermined incident solar radiation set point 440 for a given interior temperature, the electric heater is activated (represented by area 424). In this condition, insufficient solar energy is available to the radiant heater to provide heat to the interior of the climate controlled animal shelter. In one embodiment, the electric heating unit integrated inside the radiant heater is used to heat the floor and to supplement the heat provided by the hot air from the forced air electric heater.

If the level of sunlight falling on the climate controlled animal shelter is above a predetermined incident solar radiation set point 440 and above a predetermined interior temperature set point 442 represented by the area 422, the radiant heater is activated using solar heater to transfer energy to the heating material. In this condition, sufficient solar energy is available to the radiant heater to provide heat to the interior of the climate controlled animal shelter.

If the level of sunlight falling on the climate controlled animal shelter is above a predetermined incident solar radiation set point 440 and below a predetermined interior temperature set point 442 represented by the area 426, both the radiant heater (using the solar heater to transfer energy to the heating material) and the forced air electric heater are activated. By heating of the floor of the climate controlled animal shelter, the burden on the electric heater to provide heated air is lessened. In one embodiment, an electric heating unit is used to supplement the energy transferred to the heating material in the radiant heater by the solar heater.

Referring to FIG. 5, a flowchart demonstrates one embodiment of using the climate controlled animal shelter. An animal shelter, multiple climate control units (air conditioner, evaporative cooler, electric heater, radiant heater), and an occupancy/proximity detector are provided in step 502. In one embodiment, the animal shelter may be a preexisting shelter in which the climate control units are retrofitted. In one embodiment, the animal shelter may be constructed together with the climate control units.

In step 504, the method determines if the animal shelter is occupied or if the residing animal is within proximity of the animal shelter.

If the method determines in step 504 that the animal shelter is occupied or the residing animal is within proximity of the animal shelter, then the method transitions from step 504 to step 508 wherein the method assigns a first temperature set point as the target temperature. The target temperature is used to activate the heating climate control units (as represented by the heater temperature set point 420 in FIG. 4) or the cooling climate control units (as represented by the cooler temperature set points 404 in FIG. 4).

Alternately, if the method determines in step 504 that the animal shelter is not occupied or the residing animal is not within proximity of the animal shelter, then the method transitions from step 504 to step 506 wherein the method enters an energy-saving mode and assigns a second temperature set point as the target temperature. The target temperature is either below the heater temperature set point 420 in FIG. 4 or above the cooler temperature set point 404 in FIG. 4.

In step 510, the method determines if the interior temperature within the shelter is within the comfort zone.

If the method determines in step 510 that the interior temperature is within the comfort zone, then the method takes no action and transitions back to step 510.

Alternately, if the method determines in step 510 that the interior temperature is not within the comfort zone, then the method transitions from step 510 to step 512 wherein one of more of the climate control units are activated based on the external environmental conditions and the interior temperature within the animal shelter. In one embodiment, the climate control units are activated consistent with FIG. 4.

The various steps or acts in a method or process may be performed in the order shown, or may be performed in another order. For example, in certain implementations, individual steps recited in FIG. 5 may be eliminated or reordered.

Additionally, one or more process or method steps may be omitted or one or more process or method steps may be added to the methods and processes. An additional step, block, or action may be added in the beginning, end, or intervening existing elements of the methods and processes. Based on the disclosure and teachings provided herein, a person of ordinary skill in the art will appreciate other ways and/or methods to implement the present invention.

It is understood that the examples and implementations described herein are for illustrative purposes only and that various modifications or changes in light thereof will be suggested to persons skilled in the art and are to be included within the spirit and purview of this application.

What is claimed is:

1. A climate controlled animal shelter, comprising:
an interior volume;
a climate unit in fluid communication with said interior volume, said climate unit comprising:
an air conditioner;
an evaporative cooler;
an electric heater; and
a radiant heater.

2. The climate controlled animal shelter of claim 1, wherein:
an output port of said air conditioner is in fluid communication with an input port of said evaporative cooler;
an output port of said evaporative cooler is in fluid communication with an input port of said electric heater; and
an output port of said electric heater is in fluid communication with said interior volume of the animal shelter.

3. The climate controlled animal shelter of claim 1, wherein:
said climate unit is configured to receive air and deliver said air into the interior volume; and
said air passes through each of said air conditioner, said evaporative cooler, and said electric heater before being delivered into said interior volume.

4. The climate controlled animal shelter of claim 3, further comprising:
a control unit in communication with said air conditioner, said evaporative cooler, said heater, said radiant heater and a proximity sensor, wherein:
said proximity sensor is configured to receive proximity information; and
said control unit is configured to:
receive internal environmental data;
receive ambient environmental data;
receive proximity data from a transmitter; and
control each of said air conditioner, evaporative cooler, said electric heater, and said radiant heater based on said internal environmental data, said ambient environmental data, and said proximity data.

5. The climate controlled animal shelter of claim 4, wherein said radiant heater comprises:
a length of tubing attached to said animal shelter, wherein said length of tubing is disposed within a base of said animal shelter;
a quantity of heating material disposed within said length of tubing, wherein said heating material is configured to receive thermal energy and radiate said received thermal energy into said interior volume; and
a heating unit configured to deliver thermal energy to said heating material.

6. The climate controlled animal shelter of claim 5, wherein said heating unit comprises an electric heating unit configured to deliver thermal energy to said heating material.

7. The climate controlled animal shelter of claim 5, wherein said heating unit comprises a solar collection unit configured to deliver thermal energy to said heating material.

8. The climate controlled animal shelter of claim 7, wherein said solar collection unit comprises a box with an optically transparent top and a solar collection pipe disposed within said box.

9. The climate controlled animal shelter of claim 4, wherein said proximity sensor comprises a switch attached proximate an entry door disposed on said animal shelter, wherein:
the control unit is configured to activate said climate unit when an animal enters the interior volume; and
the control unit is configured to deactivate said climate unit when the animal exits the interior volume.

10. The climate controlled animal shelter of claim 4, wherein said proximity sensor comprises a wireless communication interface, wherein:
the wireless communication interface is configured to:
receive a proximity signal from a transmitter disposed on an animal; and
determine a distance between the transmitter and the wireless communication interface;
the control unit is configured to activate said climate unit when the animal approaches within a predetermined proximity of said animal shelter; and
the control unit is configured to deactivate said climate unit when the said animal retreats outside said predetermined proximity of said animal shelter.

11. The climate controlled animal shelter of claim 5, wherein:
the climate unit further comprises:
a first inlet port to receive ambient air; and
a second inlet port to receive air from said interior volume; and
the control unit is configured to control a flow of air into each of the first inlet port and the second inlet port.

12. A method for controlling a climate controlled animal shelter, comprising:
receiving a proximity value;
comparing said proximity value with a predetermined proximity set point to find a proximity match;
receiving an interior temperature within said animal shelter;
comparing said interior temperature with a predetermined temperature range; and
when the proximity match is found and the interior temperature is outside the predetermined temperature range, activating a climate unit.

13. The method of claim 12, wherein activating said climate unit comprises:
receiving an ambient humidity value;
comparing said ambient humidity value with a predetermined humidity range; and
when said ambient humidity value is greater than said predetermined humidity range, activating an air conditioner.

14. The method of claim 13, wherein activating said climate unit further comprises when said ambient humidity value is less than said predetermined humidity range, activating an evaporative cooler.

15. The method of claim 14, further comprising when said ambient humidity value is within said predetermined humidity range, activating both said air conditioner and said evaporative cooler.

16. The method of claim 14, wherein activating said climate unit further comprises:
receiving a incident solar radiation value;
comparing said incident solar radiation value with a predetermined incident solar radiation set point;
comparing said interior temperature with a predetermined temperature set point; and
when said incident solar radiation value is less than said predetermined incident solar radiation set point, activating at least one heater from the group consisting of an electric radiant heater and an electric forced air heater.

17. The method of claim 16, wherein activating said climate unit further comprises when said incident sunlight value is greater than said predetermined incident light set point and when said interior temperature is less than said predetermined temperature set point, activating a solar radiant heater.

18. The method of claim 17, wherein activating said climate unit further comprises when said incident sunlight value is greater than said predetermined incident light set point and when said interior temperature is greater than said predetermined temperature set point:
activating said solar radiant heater; and
activating at least one heater from the group consisting of a electric radiant heater and a electric forced air heater.

19. The method of claim 18, further comprising:
receiving an ambient temperature value; and
wherein activating said climate unit further comprises:
when said ambient temperature value is between said predetermined temperature range and said internal temperature value, drawing air from outside said animal shelter from a first inlet port; and
when said internal temperature value is between said predetermined temperature range and said ambient temperature value, drawing air from said interior of said animal shelter from a second inlet port.

20. The method of claim 19, further comprising a wireless display unit in two-way communication with said control unit.
